(19) United States
(12) Patent Application Publication
(10) Pub. No.: US 2025/0245571 A1
(43) Pub. Date: Jul. 31, 2025

(54) LARGE MODEL FEDERATED LEARNING METHODS AND APPARATUSES, STORAGE MEDIA, AND ELECTRONIC DEVICES

(71) Applicant: Alipay (Hangzhou) Information Technology Co., Ltd., Hangzhou (CN)

(72) Inventors: Ruofan Wu, Hangzhou (CN); Tengfei Liu, Hangzhou (CN); Tianyi Zhang, Hangzhou (CN); Weiqiang Wang, Hangzhou (CN)

(73) Assignee: Alipay (Hangzhou) Information Technology Co., Ltd., Hangzhou (CN)

(21) Appl. No.: 19/042,287

(22) Filed: Jan. 31, 2025

(30) Foreign Application Priority Data
Jan. 31, 2024 (CN) 202410140527.8

(51) Int. Cl. G06N 20/00

(52) U.S. Cl. CPC G06N 20/00

(57) ABSTRACT

Described is large model federated learning applied to a server. For each participating client device, an incremental parameter is sent by the client device after the client device trains a target large model of the client device, where a model parameter of the client device includes an original parameter and an incremental parameter, a magnitude of the incremental parameter is less than a magnitude of the original parameter, the original parameter remains unchanged, and the incremental parameter changes. The incremental parameter of the client device is aggregated by using incremental parameters of all client devices to obtain an aggregation parameter returned to the client device and used to update the incremental parameter of the client device. Based on the original parameter and an updated incremental parameter, redetermining a model parameter, used until target large model convergence in retraining the target large model.

### CROSS-REFERENCE TO RELATED APPLICATIONS

This application claims priority to Chinese Patent Application No. 202410140527.8, filed on Jan. 31, 2024, which is hereby incorporated by reference in its entirety.

### TECHNICAL FIELD

This specification relates to the field of computer technologies, and in particular, to large model federated learning methods and apparatuses, storage media, and electronic devices.

### BACKGROUND

Federated learning is a commonly used distributed machine learning method that can enable participants to exchange model parameters through secure mechanisms without leaking raw data, thereby achieving collaborative training. Such a method can effectively assist a plurality of institutions in collaborative training of neural network models while protecting private data.

With continuous development of artificial intelligence technologies, the application of large models based on artificial intelligence in various fields is becoming increasingly widespread, for example, generative models such as large language models (LLMs). Due to an extremely large quantity of parameters of large models, typically exceeding one billion, the frequent exchange of model parameters in federated learning is lengthy and complex, resulting in significant costs.

Therefore, how to implement federated learning for large models more simply and efficiently is an urgent problem to be resolved.

### SUMMARY

This specification provides large model federated learning methods and apparatuses, storage media, and electronic devices to at least partially alleviate the above-mentioned problem in a conventional technology.

The following technical solutions are used in this specification.

This specification provides a large model federated learning method, where the method is applied to a server, including: for each client device participating in federated learning, receiving an incremental parameter sent by the client device after the client device trains a target large model of the client device, where a model parameter of the client device includes an original parameter and an incremental parameter, a magnitude of the incremental parameter is less than a magnitude of the original parameter, and when the client device trains the target large model, the original parameter remains unchanged, and the incremental parameter changes; aggregating the incremental parameter of the client device by using incremental parameters of all client devices to obtain an aggregation parameter of the client device, where target large models of all the client devices have a same model structure; and returning the aggregation parameter to the client device so that the client device updates the incremental parameter of the client device based on the aggregation parameter, redetermines a model parameter based on the original parameter and an updated incremental parameter, and retrains the target large model by using the redetermined model parameter, until the target large model converges.

Optionally, the aggregating the incremental parameter of the client device by using incremental parameters of all client devices to obtain an aggregation parameter of the client device specifically includes: determining an aggregation weight between the incremental parameter of the client device and an incremental parameter of each client device; and aggregating the incremental parameter of the client device by using the incremental parameters of all the client devices based on the aggregation weight to obtain the aggregation parameter of the client device.

Optionally, the determining an aggregation weight between the incremental parameter of the client device and an incremental parameter of each client device specifically includes: determining a total quantity of training samples used by all the client devices to train the target large model; determining a client device participating in federated learning as an aggregation client device, and determining the client device as a target client device; for each aggregation client device, determining a ratio of a quantity of training samples used by the aggregation client device to train the target large model to the total quantity, and determining a similarity between an incremental parameter of the aggregation client device and an incremental parameter of the target client device; and determining an aggregation weight between the aggregation client device and the target client device based on the ratio and the similarity.

This specification provides a large model federated learning method, where the method is applied to a client device, including: obtaining a target large model, freezing an original parameter of the target large model, and initializing an incremental parameter of the target large model, where a model parameter of the target large model includes the original parameter and the incremental parameter, and a magnitude of the incremental parameter is less than a magnitude of the original parameter; training the target large model, and adjusting the incremental parameter of the target large model; sending the incremental parameter to a server to obtain an aggregation parameter returned by the server, where the aggregation parameter is obtained by the server through aggregation based on incremental parameters sent by all client devices participating in federated learning; and updating the incremental parameter of the target large model based on the aggregation parameter, redetermining a model parameter of the target large model based on the original parameter and an updated incremental parameter, and retraining the target large model by using the redetermined model parameter, until the target large model converges.

Optionally, the adjusting the incremental parameter of the target large model specifically includes: adjusting the incremental parameter of the target large model by using a regularization rule.

This specification provides a large model federated learning apparatus, including the following: a receiving module, configured to: for each client device participating in federated learning, receive an incremental parameter sent by the client device after the client device trains a target large model of the client device, where a model parameter of the client device includes an original parameter and an incremental parameter, a magnitude of the incremental parameter is less than a magnitude of the original parameter, and when the client device trains the target large model, the original parameter remains unchanged, and the incremental parameter changes; an aggregation module, configured to aggregate the incremental parameter of the client device by using incremental parameters of all client devices to obtain an aggregation parameter of the client device, where target large models of all the client devices have a same model structure; and a returning module, configured to return the aggregation parameter to the client device so that the client device updates the incremental parameter of the client device based on the aggregation parameter, redetermines a model parameter based on the original parameter and an updated incremental parameter, and retrains the target large model by using the redetermined model parameter, until the target large model converges.

Optionally, the aggregation module is specifically configured to determine an aggregation weight between the incremental parameter of the client device and an incremental parameter of each client device; and aggregate the incremental parameter of the client device by using the incremental parameters of all the client devices based on the aggregation weight to obtain the aggregation parameter of the client device.

Optionally, the aggregation module is specifically configured to determine a total quantity of training samples used by all the client devices to train the target large model; determine a client device participating in federated learning as an aggregation client device, and determine the client device as a target client device; for each aggregation client device, determine a ratio of a quantity of training samples used by the aggregation client device to train the target large model to the total quantity, and determine a similarity between an incremental parameter of the aggregation client device and an incremental parameter of the target client device; and determine an aggregation weight between the aggregation client device and the target client device based on the ratio and the similarity.

This specification provides a large model federated learning apparatus, including the following: an acquisition module, configured to obtain a target large model, freeze an original parameter of the target large model, and initialize an incremental parameter of the target large model, where a model parameter of the target large model includes the original parameter and the incremental parameter, and a magnitude of the incremental parameter is less than a magnitude of the original parameter; a training module, configured to train the target large model, and adjust the incremental parameter of the target large model; a sending module, configured to send the incremental parameter to a server to obtain an aggregation parameter returned by the server, where the aggregation parameter is obtained by the server through aggregation based on incremental parameters sent by all client devices participating in federated learning; and an updating module, configured to update the incremental parameter of the target large model based on the aggregation parameter, redetermine a model parameter of the target large model based on the original parameter and an updated incremental parameter, and retrain the target large model by using the redetermined model parameter, until the target large model converges.

Optionally, the training module is specifically configured to adjust the incremental parameter of the target large model by using a regularization rule.

This specification provides a computer-readable storage medium. The storage medium stores a computer program. When the computer program is executed by a processor, the above-mentioned large model federated learning method is implemented.

This specification provides an electronic device, including a memory, a processor, and a computer program that is stored in the memory and that is capable of running on the processor. When the processor executes the computer program, the above-mentioned large model federated learning method is implemented.

At least one of the above-mentioned technical solutions used in this specification can achieve the following beneficial effects:

In the large model federated learning method provided in this specification, for each client device participating in federated learning, an incremental parameter sent by the client device after the client device trains a target large model of the client device is received, where a model parameter of the client device includes an original parameter and an incremental parameter, a magnitude of the incremental parameter is less than a magnitude of the original parameter, and when the client device trains the target large model, the original parameter remains unchanged, and the incremental parameter changes; the incremental parameter of the client device is aggregated by using incremental parameters of all client devices to obtain an aggregation parameter of the client device, where target large models of all the client devices have a same model structure; and the aggregation parameter is returned to the client device so that the client device updates the incremental parameter of the client device based on the aggregation parameter, redetermines a model parameter based on the original parameter and an updated incremental parameter, and retrains the target large model by using the redetermined model parameter, until the target large model converges.

When federated learning for large models is performed by using the large model federated learning method provided in this specification, all client devices participating in federated learning can be enabled to freeze an original parameter of the target large model, additionally set an incremental parameter, and adjust only the incremental parameter when training the target large model. After each time of training, the client device transmits an incremental parameter only to a server, and the server aggregates incremental parameters of all the client devices to obtain aggregation parameters of all the client devices. Finally, the server can return an aggregation parameter to the client device, and the client device uses the aggregation parameter as a new incremental parameter to retrain the target large model, until the target large model converges. Using this method can effectively reduce an amount of data that needs to be transmitted between all client devices and a server in a federated learning process, thereby greatly improving the federated learning efficiency while ensuring the collaborative training effect.

### BRIEF DESCRIPTION OF DRAWINGS

The accompanying drawings described here are used to provide a further understanding of this specification, and constitute a part of this specification. Example embodiments of this specification and descriptions of the embodiments are used to explain this specification, and do not constitute an inappropriate limitation on this specification. In the accompanying drawings:

FIG. 1 is a schematic flowchart illustrating a large model federated learning method applied to a server, according to this specification;

FIG. 2 is a schematic diagram illustrating interactions between client devices and a server, according to this specification;

FIG. 3 is a schematic flowchart illustrating a large model federated learning method applied to a client device, according to this specification;

FIG. 4 is a schematic diagram illustrating a large model federated learning apparatus, according to this specification;

FIG. 5 is a schematic diagram illustrating another large model federated learning apparatus, according to this specification; and

FIG. 6 is a schematic diagram illustrating an electronic device corresponding to FIG. 1, according to this specification.

### DESCRIPTION OF EMBODIMENTS

To make the objectives, technical solutions, and advantages of this specification clearer, the following clearly and comprehensively describes the technical solutions of this specification with reference to specific embodiments of this specification and corresponding accompanying drawings. It is clear that the described embodiments are merely some rather than all of embodiments of this specification. Based on embodiments of this specification, all other embodiments obtained by a person of ordinary skill in the art without creative efforts fall within the protection scope of this specification.

The following describes in detail the technical solutions provided in embodiments of this specification with reference to the accompanying drawings.

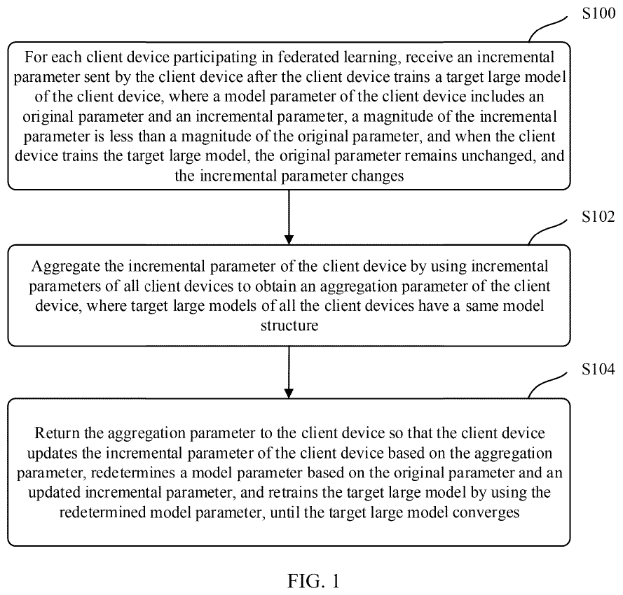

FIG. 1 is a schematic flowchart illustrating a large model federated learning method applied to a server, according to this specification. The method includes the following steps:

S100: For each client device participating in federated learning, receive an incremental parameter sent by the client device after the client device trains a target large model of the client device, where a model parameter of the client device includes an original parameter and an incremental parameter, a magnitude of the incremental parameter is less than a magnitude of the original parameter, and when the client device trains the target large model, the original parameter remains unchanged, and the incremental parameter changes.

In this specification, an execution body for implementing the large model federated learning method can be a specified device such as a server disposed on a service platform. For ease of description, this specification uses only an example in which the server is the execution body to describe a large model federated learning method provided in this specification.

This method is mainly applied to a scenario in which federated learning is performed for a large model. In this method, there are client devices participating in federated learning and a server that is trusted by all client devices. The client devices trains the target large model, and the server helps all the client devices complete parameter exchange of the model. This method is described by using the server as the execution body.

In this method, the server can first receive incremental parameters sent by all the client devices after all the client devices train the target large model. Generally, a plurality of client devices need to participate in federated learning to achieve a target of collaborative training. The target large model is a large model on which collaborative training needs to be performed. For each client device, there is one target large model. The target large models may be models with a huge quantity of any parameter magnitude, for example, large language models or vision large models. Because the parameter magnitude of the target large model is too huge, a conventional parameter exchange policy is difficult to achieve. Therefore, in this method, model parameters of a target large model in each client device are divided into an original parameter and an incremental parameter. A magnitude of the incremental parameter is far less than a magnitude of the original parameter. When all client devices train the target large model, the original parameter is frozen and does not change, and only the incremental parameter changes. The original parameter is an initial parameter of the target large model when the client device has not trained the target large model. The incremental parameter is a change amount of a current model parameter of the target large model compared with the original parameter after training of the client device. Generally, the original parameter is added to the incremental parameter to obtain the model parameter of the target large model. It is worthwhile to note that training performed by the client device on the target large model is specialized training performed based on needs. The target large model obtained by the client device is a target large model that has been trained, in other words, the target large model can complete some common general tasks by depending only on the original parameter.

During implementation of the above-mentioned method, an additional incremental parameter can be added to the target large model by using a method such as Low-Rank Adaptation (LoRA) or FedCLIP. This specification is described here by using the LoRA method as an example. The LoRA method is a low-rank self-adaption method used to train a large model. A core idea of the LoRA method is to simulate a change amount of a parameter through low rank decomposition, so as to indirectly train a parameter of a neural network. In a training process, the original parameter of the target large model is fixed, an update amount of a parameter, that is, the incremental parameter, is simulated by using matrices A and B obtained through low rank decomposition. Specifically, a bypass is added to the original target large model, and the update amount of the parameter is simulated through low rank decomposition (first in descending order of dimensions and then in ascending order of dimensions). During training, the original parameter of the target large model remains unchanged, and only the dimension reduction matrix A and the dimension increase matrix B are trained. During application, the matrix B can be multiplied by the matrix A to obtain an incremental parameter, which is added to the original parameter to serve the model parameter of the target large model, and no additional inference delay is introduced.

Each time the client device trains the target large model, adjustment on the model parameter of the target large model is usually fine-tuning. In other words, most parameters in the model parameter of the target large model do not change. Therefore, in the incremental parameter, values of many elements are 0. When the incremental parameter is transmitted between the client device and the server, a parameter with an element value of 0 does not need to be transmitted. Therefore, during transmission, the magnitude of the incremental parameter is far less than the magnitude of the original parameter, thereby greatly reducing an amount of data that needs to be transmitted while still ensuring a relatively good model training effect.

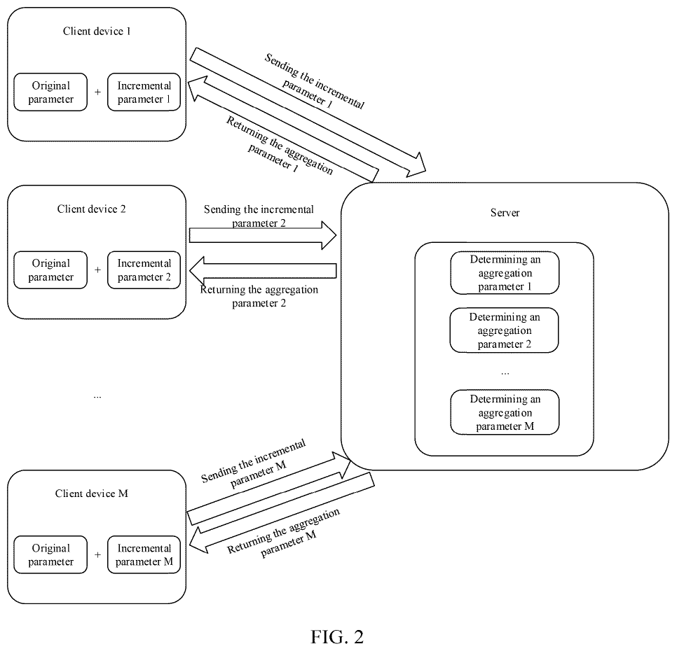

FIG. 2 is a schematic diagram illustrating interactions between client devices and a server, according to this specification. As shown in FIG. 2, a model parameter of a client device, that is, a model parameter of a target large model includes an original parameter and an incremental parameter. In this step, all client devices can send respective incremental parameters to the server in parallel. After receiving the incremental parameters sent by all the client devices, the server performs a subsequent step.

S102: Aggregate the incremental parameter of the client device by using the incremental parameters of all the client devices to obtain an aggregation parameter of the client device, where target large models of all the client devices have a same model structure.

In this step, the server can aggregate the incremental parameters of all the client devices so that each client device learns incremental parameters obtained through training by other client devices by using training samples, to achieve collaborative training of all the client devices. It is worthwhile to note that the target large models of all the client devices should have a same model structure and directions during training should also be the same, to ensure that the incremental parameters of all the client devices can be positively mutually learned.

Because each client device has a different data distribution when training the target large model, each client device finally needs a different model parameter, that is, each client device has a different incremental parameter when completing federated learning. Based on this, in this step, the server needs to perform personalized aggregation for each different client device. Specifically, when an aggregation parameter of a client device is determined, an aggregation weight between an incremental parameter of the client device and an incremental parameter of each client device can be determined; and the incremental parameter of the client device is aggregated by using the incremental parameters of all the client devices based on the aggregation weight to obtain the aggregation parameter of the client device.

Actually, the process of aggregating the incremental parameter can be viewed as a weighted summation process. For any client device, an aggregation weight between an incremental parameter of the client device and an incremental parameter of each client device can be determined. In an actual application process, there can be a plurality of manners for determining the aggregation weight. This specification provides a feasible embodiment here for reference. Specifically, a total quantity of training samples used by all the client devices to train the target large model can be determined; a client device participating in federated learning is determined as an aggregation client device, and the client device is determined as a target client device; for each aggregation client device, a ratio of a quantity of training samples used by the aggregation client device to train the target large model to the total quantity is determined, and a similarity between an incremental parameter of the aggregation client device and an incremental parameter of the target client device is determined; and an aggregation weight between the aggregation client device and the target client device is determined based on the ratio and the similarity.

For each different client device, the server needs to separately determine an aggregation parameter. However, because the server determines aggregation parameters of all the client devices by using a same method, this specification is described here by using an example of a process of determining an aggregation parameter of one client device. In this case, all the client devices participating in federated learning can be determined as aggregation client devices, and a client device whose aggregation parameter is being determined is determined as the target client device. It is worthwhile to note that when the aggregation parameter of the target client device is determined, the incremental parameter of the target client device also needs to participate in aggregation. Therefore, the target client device is also an aggregation client device.

It should be understood that in a process of determining the aggregation parameter of the target client device, a sum of aggregation weights between the incremental parameter of the target client device and incremental parameters of all aggregation client devices should be 1. In this method, it is considered that an aggregation weight between an incremental parameter of an aggregation client device and an incremental parameter of a target client device is mainly affected by two factors.

On the one hand, in normal training, when an aggregation client device trains a target large model of an aggregation client device, a larger quantity of used training samples indicates higher reliability of an incremental parameter of the aggregation client device and a larger aggregation weight between the incremental parameter of the aggregation client device and an incremental parameter of the target client device. In this step, the influence of this factor is quantified by using a ratio of the quantity of training samples used by the aggregation client device to train the target large model of the aggregation client device to a total quantity of training samples used by all aggregation client devices to train all target large models.

On the other hand, a similarity between any two incremental parameters can be determined. A higher similarity indicates more similar training samples used by a client device to which the two incremental parameters belong to train the target large model and a larger aggregation weight between the two incremental parameters. Based on this, a similarity between the incremental parameter of the target client device and an incremental parameter of each aggregation client device can be determined.

According to the above-mentioned idea, the aggregation weight can be determined by using the following formula:

$${min}_{{\{ {W}_{i j} \}}_{j}} {\sum }_{j} {( {W}_{ij} - {p}_{j} )}^{2} - α {\sum }_{j} {W}_{ij} cos ( {θ}_{i} , {θ}_{j} )$$

$$s . t . {\sum }_{j} {W}_{i} = 1 , ∀ i ; {W}_{ij} \geq 0 , ∀ i , j$$

where Wᵢⱼ indicates an aggregation weight between a target client device i and an aggregation client device j, pⱼ indicates a ratio of a quantity of training samples used by the aggregation client device j to a total quantity of training samples, θᵢ indicates an incremental parameter of the target client device i, θⱼ indicates an incremental parameter of the aggregation client device j, cos indicates a cosine similarity, and a is a hyperparameter that can be set based on specific needs. By using the above-mentioned formula, aggregation weights between the incremental parameter of the target client device and incremental parameters of all aggregation client devices can be determined.

Subsequently, the aggregation parameter of the target client device can be determined according to the following formula:

$${\tilde{Θ}}_{ι} = {\sum }_{j} {W}_{i j} {θ}_{j}$$

where \tilde{θ}ₗ is the aggregation parameter of the target client device, and weighted summation is performed on the incremental parameters of all the aggregation client devices based on the aggregation weights of all the aggregation client devices to obtain the aggregation parameter of the target client device. When an aggregation parameter of each client device is determined, determining can be performed by using the client device as the target client device.

S104: Return the aggregation parameter to the client device so that the client device updates the incremental parameter of the client device based on the aggregation parameter, redetermines a model parameter based on the original parameter and an updated incremental parameter, and retrains the target large model by using the redetermined model parameter, until the target large model converges.

Actually, the process of determining the aggregation parameter in step S102 is a process of mutually learning and integrating the incremental parameters of all the client devices. As shown in FIG. 2, in this step, the determined aggregation parameter can be further returned to a corresponding client device. For any client device, when the server returns the aggregation parameter of the client device to the client device, the client device can update the incremental parameter, that is, use the received aggregation parameter as a new incremental parameter. In addition, with reference to the frozen original parameter and the updated incremental parameter, the client device can redetermine a new model parameter and use the redetermined model parameter for the target large model to retrain the target large model.

The large model federated learning method provided in this specification is a method that requires loop execution. In this step, after receiving the aggregation parameter returned by the server, updating an incremental parameter, and redetermining a model parameter, a client device can retrain the target large model of the client device and determine whether the target large model converges. If the target large model does not converge, it indicates that federated learning needs to be performed continuously. In this case, return to step S100. The client device resends the current incremental parameter to the server and re-performs this method. The target large model converges until step S104 is performed.

Additionally, it should be considered that in the federated learning process, rounds of training performed when the target large models of all the client devices participating in the federated learning converge may be different. Therefore, in this method, a fixed quantity of rounds of training can be set to replace convergence constraints of the target large models. In addition, when a target large model of a client device has converged, training of the client device can be stopped, and an incremental parameter of the converged target large model is sent to the server. The server stores the incremental parameter of the client device and uses the incremental parameter in subsequent training of another client device whose target large model has not converged, until the target large models of all the client devices converge.

When federated learning for large models is performed by using the large model federated learning method provided in this specification, all client devices participating in federated learning can be enabled to freeze an original parameter of the target large model, additionally set an incremental parameter, and adjust only the incremental parameter when training the target large model. After each time of training, the client device transmits an incremental parameter only to a server, and the server aggregates incremental parameters of all the client devices to obtain aggregation parameters of all the client devices. Finally, the server can return an aggregation parameter to the client device, and the client device uses the aggregation parameter as a new incremental parameter to retrain the target large model, until the target large model converges. Using this method can effectively reduce an amount of data that needs to be transmitted between all client devices and a server in a federated learning process, thereby greatly improving the federated learning efficiency while ensuring the collaborative training effect.

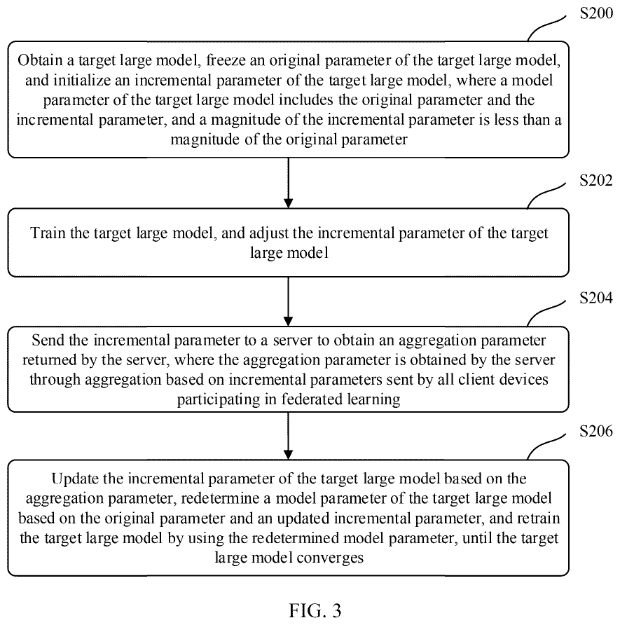

FIG. 3 is a schematic flowchart illustrating a large model federated learning method applied to a client device, according to this specification. The method includes the following steps:

S200: Obtain a target large model, freeze an original parameter of the target large model, and initialize an incremental parameter of the target large model, where a model parameter of the target large model includes the original parameter and the incremental parameter, and a magnitude of the incremental parameter is less than a magnitude of the original parameter.

S202: Train the target large model, and adjust the incremental parameter of the target large model.

S204: Send the incremental parameter to a server to obtain an aggregation parameter returned by the server, where the aggregation parameter is obtained by the server through aggregation based on incremental parameters sent by all client devices participating in federated learning.

S206: Update the incremental parameter of the target large model based on the aggregation parameter, redetermine a model parameter of the target large model based on the original parameter and an updated incremental parameter, and retrain the target large model by using the redetermined model parameter, until the target large model converges.

Federated learning needs to be performed by the client device and the server together. Therefore, the large model federated learning method that is applied to the server and that is provided in this specification and the large model federated learning method that is applied to the client device need to be performed simultaneously. The large model federated learning method applied to the client device and the large model federated learning method applied to the server are actually a same method implemented on different execution bodies on two sides. The method is described in detail in the large model federated learning method applied to the server. Details are not described here again.

It is worthwhile to note that the target large model does not overfit when the client device trains the target large model, and a regularization method can be used when the incremental parameter of the target large model is adjusted, to constrain the degree of change in the incremental parameters and ensure that the training performed by the client device on the target large model is effective. There can be a plurality of usable regularization methods, including but not limited to methods such as L1 regularization, L2 regularization, and Dropout. Implementations are not limited in this application.

The large model federated learning method provided in this specification can be applied to any scenario in which federated learning is performed for large models. This specification provides a specific embodiment here for reference. Specifically, for example, the large model federated learning method provided in this specification can be applied to a risk control scenario, and a risk control large model configured to predict whether a user has a risk is collaboratively trained. In this case, when performing the large model federated learning method provided in this specification, all client devices can use information of the user in the risk control scenario as training samples and use whether the user corresponding to the information has a risk as a label to train the target large model. It can be imagined that the large model federated learning method provided in this specification can also be applied to various other scenarios. Details are omitted here in this application for simplicity.

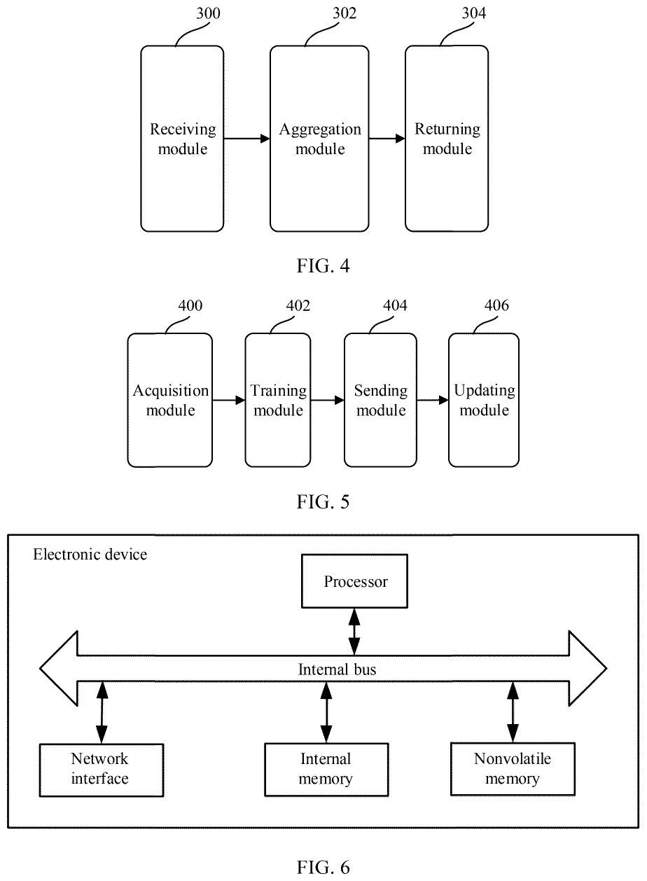

One or more methods for implementing large model federated learning in this specification are described above. Based on the same idea, this specification further provides corresponding large model federated learning apparatuses, as shown in FIG. 4 and FIG. 5.

FIG. 4 is a schematic diagram illustrating a large model federated learning apparatus, according to this specification. The apparatus includes the following: a receiving module 300, configured to: for each client device participating in federated learning, receive an incremental parameter sent by the client device after the client device trains a target large model of the client device, where a model parameter of the client device includes an original parameter and an incremental parameter, a magnitude of the incremental parameter is less than a magnitude of the original parameter, and when the client device trains the target large model, the original parameter remains unchanged, and the incremental parameter changes; an aggregation module 302, configured to aggregate the incremental parameter of the client device by using incremental parameters of all client devices to obtain an aggregation parameter of the client device, where target large models of all the client devices have a same model structure; and a returning module 304, configured to return the aggregation parameter to the client device so that the client device updates the incremental parameter of the client device based on the aggregation parameter, redetermines a model parameter based on the original parameter and an updated incremental parameter, and retrains the target large model by using the redetermined model parameter, until the target large model converges.

Optionally, the aggregation module 302 is specifically configured to determine an aggregation weight between the incremental parameter of the client device and an incremental parameter of each client device; and aggregate the incremental parameter of the client device by using the incremental parameters of all the client devices based on the aggregation weight to obtain the aggregation parameter of the client device.

Optionally, the aggregation module 302 is specifically configured to determine a total quantity of training samples used by all the client devices to train the target large model; determine a client device participating in federated learning as an aggregation client device, and determine the client device as a target client device; for each aggregation client device, determine a ratio of a quantity of training samples used by the aggregation client device to train the target large model to the total quantity, and determine a similarity between an incremental parameter of the aggregation client device and an incremental parameter of the target client device; and determine an aggregation weight between the aggregation client device and the target client device based on the ratio and the similarity.

FIG. 5 is a schematic diagram illustrating a large model federated learning apparatus, according to this specification. The apparatus includes the following: an acquisition module 400, configured to obtain a target large model, freeze an original parameter of the target large model, and initialize an incremental parameter of the target large model, where a model parameter of the target large model includes the original parameter and the incremental parameter, and a magnitude of the incremental parameter is less than a magnitude of the original parameter; a training module 402, configured to train the target large model, and adjust the incremental parameter of the target large model; a sending module 404, configured to send the incremental parameter to a server to obtain an aggregation parameter returned by the server, where the aggregation parameter is obtained by the server through aggregation based on incremental parameters sent by all client devices participating in federated learning; and an updating module 406, configured to update the incremental parameter of the target large model based on the aggregation parameter, redetermine a model parameter of the target large model based on the original parameter and an updated incremental parameter, and retrain the target large model by using the redetermined model parameter, until the target large model converges.

Optionally, the training module 402 is specifically configured to adjust the incremental parameter of the target large model by using a regularization rule.

This specification further provides a computer-readable storage medium. The storage medium stores a computer program, and the computer program can be used to perform the above-mentioned the large model federated learning method provided in FIG. 1 or FIG. 3.

This specification further provides a schematic structural diagram illustrating an electronic device corresponding to FIG. 1 or FIG. 3, as shown in FIG. 6. As shown in FIG. 6, in terms of hardware, the electronic device includes a processor, an internal bus, a network interface, an internal memory, and a nonvolatile memory, and certainly may further include hardware needed by another service. The processor reads a corresponding computer program from the nonvolatile memory to the internal memory and then runs the computer program to implement the above-mentioned large model federated learning method shown in FIG. 1 or FIG. 3. Certainly, in addition to a software implementation, this specification does not rule out another implementation, for example, a logic component or a combination of software and hardware. To be specific, an execution body of the following processing procedure is not limited to each logical unit, and can be hardware or a logical component.

In the 1990s, whether a technical improvement is a hardware improvement (for example, an improvement to a circuit structure, such as a diode, a transistor, or a switch) or a software improvement (an improvement to a method procedure) can be clearly distinguished. However, with development of technologies, an improvement to many existing method procedures can be considered as a direct improvement to hardware circuit structures. A designer usually programs an improved method procedure into a hardware circuit to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. A designer autonomously performs programming to “integrate” a digital system onto a PLD, without requesting a chip manufacturer to design and manufacture a dedicated integrated circuit chip. In addition, currently, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). Currently, the Very-High-Speed Integrated Circuit Hardware Description Language (VHDL) and Verilog are most commonly used. A person skilled in the art should also understand that a hardware circuit that implements a logical method procedure can be readily obtained once the method procedure is logically programmed by using the above-mentioned several hardware description languages and is programmed into an integrated circuit.

A controller can be implemented by using any appropriate method. For example, the controller can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicon Labs C8051F320. The memory controller can also be implemented as a part of the control logic of the memory. A person skilled in the art also knows that in addition to implementing the controller by using only the computer-readable program code, logic programming can be performed on method steps to enable the controller to implement the same function in a form of a logic gate, a switch, an application-specific integrated circuit, a programmable logic controller, or an embedded microcontroller. Therefore, the controller can be considered as a hardware component, and an apparatus included in the controller and configured to implement various functions can also be considered as a structure in the hardware component. Alternatively, an apparatus configured to implement various functions can be considered as both a software module for implementing a method and a structure in a hardware component.

The systems, apparatuses, modules, or units described in the above-mentioned embodiments can be specifically implemented by a computer chip or an entity, or can be implemented by a product having a certain function. A typical implementation device is a computer. Specifically, for example, the computer can be a personal computer, a laptop computer, a cellular phone, a camera phone, a smart phone, a personal digital assistant, a media player, a navigation device, an email device, a game console, a tablet computer, a wearable device, or any combination of these devices.

For ease of description, the above-mentioned apparatus is described by dividing functions into various units. Certainly, during implementation of this specification, functions of units can be implemented in one or more pieces of software and/or hardware.

A person skilled in the art should understand that embodiments of this specification can be provided as methods, systems, or computer program products. Therefore, this specification can use a form of hardware only embodiments, software only embodiments, or embodiments with a combination of software and hardware. In addition, this specification can be in a form of a computer program product implemented on one or more computer-usable storage media (including but not limited to a magnetic disk storage, a CD-ROM, an optical storage, etc.) including computer-usable program code.

This specification is described with reference to a flowchart and/or block diagram of the method, the device (system), and the computer program product according to embodiments of this specification. It should be understood that each process and/or each block in the flowcharts and/or the block diagrams and a combination of a process and/or a block in the flowcharts and/or block diagrams can be implemented by using computer program instructions. These computer program instructions can be provided for a general-purpose computer, a dedicated computer, an embedded processor, or a processor of another programmable data processing device to generate a machine so that the instructions executed by the computer or the processor of the another programmable data processing device generate an apparatus for implementing a specific function in one or more processes in the flowcharts and/or in one or more blocks in the block diagrams.

These computer program instructions can be stored in a computer-readable memory that can instruct the computer or the another programmable data processing device to work in a specific way so that the instructions stored in the computer-readable memory generate an artifact that includes an instruction apparatus. The instruction apparatus implements a specific function in one or more processes in the flowcharts and/or in one or more blocks in the block diagrams.

These computer program instructions can alternatively be loaded onto the computer or another programmable data processing device so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPUs), one or more input/output interfaces, one or more network interfaces, and one or more internal memories.

The internal memory can include a form such as a non-persistent memory, a random access memory (RAM), or a nonvolatile memory in a computer-readable medium, for example, a read-only memory (ROM) or a flash memory (flash RAM). The internal memory is an example of the computer-readable medium.

The computer-readable medium includes persistent, non-persistent, movable, and unmovable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information that can be accessed by a computing device. As specified in this specification, the computer-readable medium does not include transitory computer-readable media (transitory media), such as a modulated data signal and carrier.

It is worthwhile to further note that the terms “include”, “comprise”, or any other variant thereof are intended to cover a non-exclusive inclusion so that a process, a method, a product, or a device that includes a list of elements not only includes those elements but also includes other elements that are not expressly listed, or further includes elements inherent to such a process, method, product, or device. Without more constraints, an element preceded by “includes a . . . ” does not preclude the presence of additional identical elements in the process, method, product, or device that includes the element.

A person skilled in the art should understand that embodiments of this specification can be provided as methods, systems, or computer program products. Therefore, a form of hardware only embodiments, software only embodiments, or embodiments with a combination of software and hardware can be used in this specification. In addition, this specification can be in a form of a computer program product implemented on one or more computer-usable storage media (including but not limited to a magnetic disk storage, a CD-ROM, an optical storage, etc.) including computer-usable program code.

This specification can be described in a general context of computer-executable instructions executed by a computer, for example, a program module. Generally, the program module includes a routine, a program, an object, a component, a data structure, etc. executing a specific task or implementing a specific abstract data type. This specification can alternatively be practiced in distributed computing environments. In the distributed computing environments, tasks are executed by remote processing devices connected through a communication network. In a distributed computing environment, the program module can be located in both local and remote computer storage media including storage devices.

The embodiments of this specification are described in a progressive manner. For same or similar parts in the embodiments, mutual references can be made to the embodiments. Each embodiment focuses on a difference from other embodiments. Particularly, the system embodiments are basically similar to the method embodiments, and therefore are described briefly. For related parts, references can be made to some descriptions in the method embodiments.

The above-mentioned descriptions are merely some embodiments of this specification and are not intended to limit this specification. A person skilled in the art can make various modifications and variations to this specification. Any modification, equivalent replacement, or improvement made without departing from the spirit and principle of this specification shall fall within the scope of the claims in this specification.

What is claimed is:

1. A computer-implemented method for large model federated learning applied to a server, comprising:
for each client device participating in federated learning:
receiving an incremental parameter sent by the client device after the client device trains a target large model of the client device, wherein a model parameter of the client device comprises an original parameter and an incremental parameter, a magnitude of the incremental parameter is less than a magnitude of the original parameter, wherein, when the client device trains the target large model of the client device, the original parameter remains unchanged, and wherein the incremental parameter changes;
aggregating the incremental parameter of the client device by using incremental parameters of all client devices to obtain an aggregation parameter of the client device, wherein target large models of all the client devices have a same model structure;
returning the aggregation parameter to the client device, so that the client device updates, based on the aggregation parameter, the incremental parameter of the client device;
redetermining, based on the original parameter and an updated incremental parameter and as a redetermined model parameter, a model parameter; and
retraining, using the redetermined model parameter and until target large model convergence, the target large model.

2. The computer-implemented method of claim 1, wherein the aggregating the incremental parameter of the client device by using incremental parameters of all client devices to obtain an aggregation parameter of the client device specifically comprises:
determining an aggregation weight between the incremental parameter of the client device and an incremental parameter of each client device.

3. The computer-implemented method of claim 2, comprising:
aggregating the incremental parameter of the client device by using the incremental parameters of all the client devices based on the aggregation weight to obtain the aggregation parameter of the client device.

4. The computer-implemented method of claim 3, wherein the determining an aggregation weight between the incremental parameter of the client device and an incremental parameter of each client device comprises:
determining a total quantity of training samples used by all the client devices to train the target large model.

5. The computer-implemented method of claim 4, comprising:
determining a client device participating in federated learning as an aggregation client device, and determining the client device as a target client device.

6. The computer-implemented method of claim 5, comprising:
for each aggregation client device, determining a ratio of a quantity of training samples used by the aggregation client device to train the target large model to the total quantity, and determining a similarity between an incremental parameter of the aggregation client device and an incremental parameter of the target client device.

7. The computer-implemented method of claim 6, comprising:
determining an aggregation weight between the aggregation client device and the target client device based on the ratio and the similarity.

8. A non-transitory, computer-readable medium storing one or more instructions executable by a computer system to perform one or more operations, comprising:
for each client device participating in federated learning:
receiving an incremental parameter sent by the client device after the client device trains a target large model of the client device, wherein a model parameter of the client device comprises an original parameter and an incremental parameter, a magnitude of the incremental parameter is less than a magnitude of the original parameter, wherein, when the client device trains the target large model of the client device, the original parameter remains unchanged, and wherein the incremental parameter changes;
aggregating the incremental parameter of the client device by using incremental parameters of all client devices to obtain an aggregation parameter of the client device, wherein target large models of all the client devices have a same model structure;
returning the aggregation parameter to the client device, so that the client device updates, based on the aggregation parameter, the incremental parameter of the client device;
redetermining, based on the original parameter and an updated incremental parameter and as a redetermined model parameter, a model parameter; and
retraining, using the redetermined model parameter and until target large model convergence, the target large model.

9. The non-transitory, computer-readable medium of claim 8, wherein the aggregating the incremental parameter of the client device by using incremental parameters of all client devices to obtain an aggregation parameter of the client device specifically comprises:
determining an aggregation weight between the incremental parameter of the client device and an incremental parameter of each client device.

10. The non-transitory, computer-readable medium of claim 9, comprising:
aggregating the incremental parameter of the client device by using the incremental parameters of all the client devices based on the aggregation weight to obtain the aggregation parameter of the client device.

11. The non-transitory, computer-readable medium of claim 10, wherein the determining an aggregation weight between the incremental parameter of the client device and an incremental parameter of each client device comprises:
determining a total quantity of training samples used by all the client devices to train the target large model.

12. The non-transitory, computer-readable medium of claim 11, comprising:
determining a client device participating in federated learning as an aggregation client device, and determining the client device as a target client device.

13. The non-transitory, computer-readable medium of claim 12, comprising:
for each aggregation client device, determining a ratio of a quantity of training samples used by the aggregation client device to train the target large model to the total quantity, and determining a similarity between an incremental parameter of the aggregation client device and an incremental parameter of the target client device.

14. The non-transitory, computer-readable medium of claim 13, comprising:
determining an aggregation weight between the aggregation client device and the target client device based on the ratio and the similarity.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
for each client device participating in federated learning:
receiving an incremental parameter sent by the client device after the client device trains a target large model of the client device, wherein a model parameter of the client device comprises an original parameter and an incremental parameter, a magnitude of the incremental parameter is less than a magnitude of the original parameter, wherein, when the client device trains the target large model of the client device, the original parameter remains unchanged, and wherein the incremental parameter changes;
aggregating the incremental parameter of the client device by using incremental parameters of all client devices to obtain an aggregation parameter of the client device, wherein target large models of all the client devices have a same model structure;
returning the aggregation parameter to the client device, so that the client device updates, based on the aggregation parameter, the incremental parameter of the client device;
redetermining, based on the original parameter and an updated incremental parameter and as a redetermined model parameter, a model parameter; and
retraining, using the redetermined model parameter and until target large model convergence, the target large model.

16. The computer-implemented system of claim 15, wherein the aggregating the incremental parameter of the client device by using incremental parameters of all client devices to obtain an aggregation parameter of the client device specifically comprises:
determining an aggregation weight between the incremental parameter of the client device and an incremental parameter of each client device.

17. The computer-implemented system of claim 16, comprising:
aggregating the incremental parameter of the client device by using the incremental parameters of all the client devices based on the aggregation weight to obtain the aggregation parameter of the client device.

18. The computer-implemented system of claim 17, wherein the determining an aggregation weight between the incremental parameter of the client device and an incremental parameter of each client device comprises:
determining a total quantity of training samples used by all the client devices to train the target large model.

19. The computer-implemented system of claim 18, comprising:
determining a client device participating in federated learning as an aggregation client device, and determining the client device as a target client device.

20. The computer-implemented system of claim 19, comprising:
for each aggregation client device, determining a ratio of a quantity of training samples used by the aggregation client device to train the target large model to the total quantity, and determining a similarity between an incremental parameter of the aggregation client device and an incremental parameter of the target client device.
